(19) United States
(12) Patent Application Publication
(10) Pub. No.: US 2026/0077539 A1
(43) Pub. Date: Mar. 19, 2026

(54) METHOD AND DEVICE FOR MONITORING THE ENERGY MANAGEMENT OF DRYER SYSTEMS FOR PLASTIC GRANULATE, AND METHOD AND DEVICE FOR DRYING PLASTIC GRANULATE

(71) Applicant: Stefan BOCK, Glarus (CH)

(72) Inventor: Stefan BOCK, Glarus (CH)

(21) Appl. No.: 19/109,063

(22) PCT Filed: Jul. 10, 2023
(86) PCT No.: PCT/EP2023/069027

§ 371 Date: Mar. 5, 2025

(30) Foreign Application Priority Data
Sep. 8, 2022 (DE) 10 2022 122 794.4

(51) Int. Cl. B29B 13/06; F26B 21/10; F26B 21/12

(52) U.S. Cl. CPC B29B 13/065; F26B 21/35; F26B 21/37; F26B 2200/08

(57) ABSTRACT

A method and a device for monitoring the energy management of dryer systems for plastic granules as well as a method and a device for drying plastic granules. Both the energy input and the energy requirement are continuously determined so that operation of the corresponding systems is optimized both in terms of product quality and energy consumption.

The invention relates to a device for monitoring the energy management of dryer systems for plastic granules.

The invention also relates to a method for monitoring the energy management of dryer systems for plastic granules.

The invention also relates to a device for drying plastic granules, comprising at least one device for monitoring the energy management of dryer systems for plastic granules, in particular for preparing plastic granules for a subsequent plasticizing process.

The invention also relates to a process for drying plastic granules with energy management monitoring.

Such devices and processes are used in particular in the manufacture of plastic products, which are usually made from plastic granulate. This applies in particular to hygroscopic granulates which must be dried before the plasticizing process in order to avoid degradation of the material during the plasticizing process. The material is also supplied with thermal energy, which significantly supports the plasticizing process: the plasticizing process becomes more stable, as the plasticizing process has to supply less energy to the plastic material for melting.

The drying process for plastic granules, which is realized with appropriate processes and devices, is already very sophisticated today. In devices designed as drying hoppers for drying plastic granules, for example, in which the material is provided for the plasticizing process, sufficiently dry process air is fed in countercurrent, which absorbs the excess moisture in a controlled manner. The process air is then dried and recycled.

The state of the art is different when it comes to the simultaneous input of thermal energy into the plastic granulate through the drying air, as this process is not given sufficient attention. The reason for this is that measuring the energy introduced into the granulate is challenging and economically impossible in the current production process, as the pellets of the plastic granulate are highly insulating, meaning that the core temperature cannot be deduced from an external temperature measurement. Although the temperature of the plastic granules is monitored with a heat sensor, only the temperature of the process air is effectively measured-the energy content inside the individual pellets remains unknown. Nevertheless, too much importance is attached to this temperature display. Typical temperatures for polyethylene terephthalate (PET), for example, are 160° C.-195°C. during drying, but can also be lower or higher. If this material is saturated at the desired temperature due to its heat absorption capacity (enthalpy of the material), the manufacturing process is optimal in terms of thermal management in production and the best article quality can be produced. If the energy input into the plastic granulate is too low, a subsequent injection molding machine requires significantly more energy to heat up the material accordingly, and the material is subjected to very high stress due to the mechanical energy input. The plasticizing screw then often fails to homogenize the melt sufficiently or the torque of the screw increases or even exceeds the limit. This leads to undissolved material and bubbles in the product. To solve the problem in today's systems, the plasticizing temperature profile is often increased in order to reduce the torque or compensate for the lack of energy-or the screw itself reaches uncontrolled high temperatures due to high friction, causing the plastic material and/or its additives to burn, resulting in black spots in the product.

It is not unusual for operators of injection molding systems to lack detailed knowledge of the energy relationship between dryers and injection molding units, as the dryer has fulfilled its main task of drying the material, which can easily be verified in the quality laboratory.

Even today, there are already operators who suspect that the process air flow in the dryer is not sufficient to saturate the plastic granulate energetically and thus also recognize the connection to the defect patterns of their product. In these cases, according to the state of the art, the air flow rate in the dryer is increased and the energy saturation of the pellets is thus achieved in order to ensure good production. In these cases, it remains unclear whether this process air then exits the drying device with excess energy. This outgoing process air flow can reach temperatures of over 60° C. and well above (e.g. 130° C.) when processing PET, for example. However, in order to dry this air efficiently, it must ideally be cooled down to approx. 60° C., which is done in a heat exchanger. Here, the operator pays for the loss of energy twice: after drying, the air must be reheated using an air drying device, such as a silicate drying cartridge or a drying wheel, while the heat exchanger directs the excess energy into a cooling machine, for example.

According to the state of the art, dryers are almost never operated at the optimum operating point due to a lack of precise and up-to-date information regarding the drying and energy saturation of the plastic granulate, as the energy content in the granulate cannot be measured. This situation is unacceptable under today's conditions, such as the desired conservation of resources, rising energy costs and the low margins that can be achieved.

Today, dryer manufacturers help themselves by using load cells to determine a system throughput of plastic granules. Depending on the manufacturer, an air factor is used to adjust the air volume to the demand. In most cases, the air volume is theoretically determined at the blower by the power consumption of the blower or its speed. The current air temperature at the fan, which determines the density of the air, and the degree of clogging of the filters are not reliably displayed. It is also misleading for the operator that the air is displayed in volume (usually in cubic meters) and not in its relevant mass. In addition, general process fluctuations, in particular the inlet temperature of the plastic granulate, are given little consideration. There are drying hoppers on the market today that regulate the air flow down to a value selected by the operator when the process air temperature at the outlet is high, but it is not clear to the operator whether the material is then energetically saturated and the heat exchanger disposes of the excess energy of the process air unnoticed. There are also no systems that plausibly combine the energy consumption with the energy requirement at the dryer. As a result, it is not uncommon for the cooling water valve on the heat exchanger to get stuck and the air to be unnecessarily cooled to well below 60° C.

In summary, in the currently known processes and devices for drying plastic granulate, the interrelationships of plastic granulate heating before the plasticizing process are almost unknown to the operators, the problem search for quality defects tends to take place in the injection molding system, or the excess energy that disappears in the process air during cooling down after drying the granulate, for example in a cooling machine, remains unnoticed in most cases.

Operators of well-known drying systems generally lack the information they need to assess the energy efficiency of the drying process themselves. Today, drying systems are offered whose manufacturers claim that they are optimally designed and operate at a correspondingly high level of quality. Unfortunately, this is rarely the case, as the external influences are too varied, or the drying machines are too old for energy management to have been relevant in their manufacture. Examples of this are:
If filters become clogged gradually, this is not considered
The inlet temperature of the granulate fluctuates depending on the season, to which known dryers react little
All dryers work with air volumes and therefore the density of the air is not sufficiently considered in the event of temperature fluctuations
The air flow is almost always calculated theoretically on the fan, there is rarely a real value
A defective heat exchanger is usually not recognized

It is therefore an object of the invention to create a device for monitoring the energy management of dryer systems for plastic granules, which at least partially solves the aforementioned problems.

According to the invention, this object is achieved by a device according to patent claim 1.

It is a further object of the invention to create a device for drying plastic granules which at least partially solves the aforementioned problems.

According to the invention, this object is achieved by a device according to patent claim 9.

It is a further object of the invention to provide a method for monitoring the energy management of dryer systems for plastic granules, which at least partially solves the aforementioned problems.

According to the invention, this object is achieved by a method according to patent claim 11.

It is a further object of the invention to provide a process for drying plastic granules which at least partially solves the aforementioned problems.

According to the invention, this object is achieved by a method according to patent claim 23.

Advantageous embodiments of the invention are claimed in the dependent patent claims.

The following disclosed features of a device for monitoring the energy management of dryer systems for plastic granules, a device for drying plastic granules, a method for monitoring the energy management of dryer systems for plastic granules and a method for drying plastic granules are part of the invention in all practicable combinations.

The basic idea of the teaching according to the invention is to determine the energy input into the plastic granulate realized with the aid of the process air, so that, in addition to drying, sufficient energetic saturation of the plastic granulate is made possible with the lowest possible losses.

In addition to the granular form of plastic, other forms of plastic, such as plastic flakes or plastic powder, can also be processed according to the invention.

In embodiments of the invention, the energy management on dryer systems can be continuously monitored or the energy management on dryer systems is continuously monitored.

A device for drying plastic granules according to the invention has at least one drying chamber, a feed device for plastic granules, a blower and a heater.

Plastic granulate can be fed into the drying chamber via the feed device. The blower can be used to create an air flow of dried process air through a process air line via a process air inlet into and through the drying chamber. The heater can be used to adjust the process air in the area of the process air duct to a desired temperature, usually in a range between about 160° C. and about 195° C. in applications for drying PET pellets. In the drying chamber, the process air and plastic granules come into contact with each other, whereby the process air absorbs moisture from the plastic granules and releases heat energy to the plastic granules.

In preferred embodiments of the invention, the drying chamber is thermally insulated, so that losses due to unwanted heat escape are significantly reduced.

A device according to the invention for drying plastic granules has at least one device for monitoring the energy management of dryer systems for plastic granules.

According to the invention, the device for monitoring the energy management of dryer systems for plastic granules has at least one temperature sensor for measuring the inlet temperature of the process air arranged or to be arranged in the region of the process air inlet and at least one temperature sensor for measuring the outlet temperature of the process air arranged or to be arranged in the region of a process air outlet from the drying chamber. Furthermore, the device for monitoring the energy management of dryer systems for plastic granules has at least one temperature sensor for measuring the inlet temperature of the plastic granules.

Furthermore, a device for monitoring the energy management of dryer systems for plastic granules according to the invention has at least one evaluation unit.

In embodiments of the invention, the input temperature of the plastic granules can be determined by measuring the temperature at a storage location of the plastic granules, provided that the plastic granules remain at this storage location long enough for the temperature prevailing there to have passed homogeneously in the plastic granules. In corresponding embodiments, an additional measurement of the surface temperature of the plastic granules in the area of the feed device of the device for drying plastic granules can be carried out for plausibility checks.

The thermal energy (energy input) emitted by the process air to the plastic granules, apart from losses, can be determined if the mass of the process air passing through the drying chamber is known. For this purpose, the device for monitoring the energy management of dryer systems for plastic granules according to the invention has a process air mass determination device.

In embodiments of the invention, the process air mass determination device is arranged or is to be arranged in the area of the process air duct and comprises an air volume measuring device. Considering the temperature-dependent density of the process air, which in embodiments of the invention can be retrieved from an electronic storage device, the mass of the process air fed into the drying chamber can be determined from the measured air volume.

Due to the strongly temperature-dependent density of air, in advantageous embodiments of the invention at least one temperature sensor is arranged in the area of the air volume measuring device, so that the density of the process air in the area of the air volume measuring device can be determined more precisely, taking the temperature into account.

In embodiments of the invention, at least one pressure sensor for determining the air pressure is additionally arranged in the area of the air volume measuring device, so that the density of the process air in the area of the air volume measuring device can be determined even more precisely, taking into account the air pressure.

In embodiments of the invention, the air volume measuring device is designed as a volume flow measuring device. In other embodiments, a velocity meter for measuring the flow velocity of the process air is integrated or can be integrated into a section of the process air supply line with a known cross-section, so that the volume of the process air introduced into the drying chamber in a specific time can also be determined.

With the aid of the evaluation unit, the absolute energy input by the process air can be determined from the difference between the input temperature and the output temperature, from which the energy input per kg of process air (specific energy input) results, considering the heat capacity of air, and taking into account the mass of the supplied process air. To simplify the calculation, the value of the specific heat capacity of air is assumed to be 1 kJ/kg/K in embodiments of the invention. This is possible in particular without major errors, since the process air is dried air.

In addition to determining the energy introduced into the process, it is essential for the invention to know the energy requirement for drying and energetic saturation of the plastic granulate. The energy requirement also depends on the mass of the plastic granulate fed into the dryer (throughput).

The evaluation unit is therefore designed to determine the throughput of plastic granules.

In embodiments of the invention, a corresponding measuring device is integrated or can be integrated into the feed device for the plastic granules in order to determine the mass of the plastic granules fed in. In other embodiments of the invention, the value for the mass of the supplied plastic granulate can be retrieved with the evaluation unit, for example if this is a predetermined process parameter, on the basis of which the feed device can be controlled accordingly with the aid of a control unit. In further embodiments, the material throughput of the dryer is synchronized with at least one downstream production unit, for example an injection molding machine, based on the material requirement and the corresponding value can be retrieved using the evaluation unit.

In embodiments of the invention for a dryer system with a downstream injection molding system, the material throughput can be automatically derived from corresponding values, considering the amount of plastic processed in one cycle of the injection molding system.

For example, values for the weight of an individual injection molded product (e.g. preform weight), the number of mold cavities of the injection molding system and the proportion of the material dried with the respective dryer in the product (e.g. preform) can be entered or retrieved. From this, the weight of the material required for one cycle of the injection molding system can be determined with the aid of the device according to the invention. In advantageous embodiments of the invention, a signal synchronized with the cycle of the injection molding system, which signals, for example, the start or end of a cycle, can be received with the aid of the device according to the invention and the cycle time of the injection molding system can be determined therefrom. From the required amount of plastic per cycle and the cycle time, the required material throughput per unit of time (e.g. per hour) can then be determined with the aid of the device according to the invention in the corresponding embodiments and can be used to calculate the throughput-dependent energy requirement.

Depending on the processed plastic or plastic mixture and the type of subsequent process, a target temperature can be specified for the plastic granulate at which sufficient energy saturation of the plastic granulate is achieved. In the case of PET and subsequent plasticization, the range for the target temperature is between approximately 160° C. and 195° C. A device for monitoring the energy management of dryer systems for plastic granules according to the invention has corresponding input means for entering the target temperature for the plastic granules.

The specific energy requirement can be determined from the difference between the target temperature and the input temperature of the plastic granulate using the evaluation unit, considering the specific heat capacity of the respective plastic granulate.

The value of the specific heat capacity can be retrieved from a memory unit using the evaluation unit.

PET granulate, for example, has a specific heat capacity of 1.5 kJ/kg/K. In the temperature range of the drying process from −40° C. to 230° C., PET material has an almost linear energy absorption (enthalpy), which makes it relatively easy to determine the specific energy requirement of the material during drying.

The absolute energy requirement or the throughput-dependent energy requirement for this temperature increase can also be determined by considering the mass of plastic granulate fed into the drying chamber.

In preferred embodiments of the invention, the energy required for the actual drying of the plastic granulate is also considered when determining the total energy requirement in addition to the energy required for the temperature increase. For example, the corresponding drying energy value for the respective material can be retrieved from a storage unit. For PET pellets, a value of around 12 kJ/kg is a common value for the drying effort.

The invention thus presents a solution for determining the optimum energy input into the plastic granules without the need to measure the temperature of the dried pellets.

In embodiments of the invention, the device for drying plastic granules has an output device, in particular designed as a display, for outputting the determined specific and/or absolute energy requirement and the determined specific and/or absolute energy input. In embodiments of the invention, the throughput-dependent values for the energy requirement and the energy input can be displayed.

In preferred embodiments of the invention, the output device is designed for comparative output of the respective values for the energy requirement and the energy input.

In advantageous embodiments of the invention, the output device is designed for simultaneous graphical output of the values, for example as progression curves over a time axis. From the difference between energy requirement and energy input, an operator of the drying device according to the invention can immediately and clearly recognize whether the system is optimally set with regard to the desired energetic saturation of the plastic granulate and the energy efficiency, or whether an adjustment of the settings must be made.

In embodiments of the invention, the device has a control unit with which the blower and/or the heater for adjusting the mass fed into the drying chamber and/or the inlet temperature of the process air can be controlled to minimize the deviation of the energy input from the energy requirement determined with the aid of the evaluation unit, so that optimized automatic control of the energy input with regard to the actual energy requirement is realized.

In embodiments of the invention, the device for drying plastic granules is designed for countercurrent drying of the plastic granules. This allows the thermal energy to be optimally transferred from the process air to the plastic granules.

In embodiments of the invention, the device for drying plastic granules is designed as a drying hopper.

In embodiments of the invention, the apparatus for drying plastic granules has a process air circuit in which the process air is reused.

After drying the plastic granulate, the process air has absorbed the corresponding moisture and must be dried itself before it can be used again.

For drying the process air, the device for drying plastic granulate has a process air drying device in corresponding embodiments.

In embodiments of the invention, for example, a drying cartridge or a drying wheel, e.g. made of silicate, is used to dry the process air.

However, if the process air is too hot (usually over 60° C.), it cannot be dried sufficiently using the known process air drying equipment.

In order to cool the process air down accordingly after it leaves the drying chamber, the device for drying plastic granules has a heat exchanger arranged upstream of the process air drying device in corresponding embodiments.

In embodiments of the invention, the heat exchanger is coupled to a cooling machine. The more the process air has to be cooled down for drying, the higher the energy requirement for operating the cooling machine in corresponding embodiments.

It thus becomes clear that in corresponding embodiments, an unnecessarily high set process air temperature or process air volume firstly requires an unnecessarily high energy input for the provision of the process air and secondly requires an unnecessarily high energy input for the subsequent cooling of the process air.

In embodiments of the invention, this excess energy is represented specifically per kg of plastic material in a third curve as a loss.

In order to detect the energy required to cool the process air, the device according to the invention for monitoring energy management in dryer systems for plastic granules in corresponding embodiments has at least one temperature sensor arranged or to be arranged in the process air line downstream of the heat exchanger in the direction of flow. The specific energy loss can be determined from the difference between the output temperature measured in the area of the process air outlet and the measured temperature value of the cooled process air.

The setting of the drying device can be optimized on the basis of the specific energy curves by adjusting the temperature and/or the volume flow of the process air in such a way that the curves of the specific energy input and the specific energy requirement lie approximately over each other and the loss curve is minimized at the same time.

In preferred embodiments of the device according to the invention with a determination of the energy loss, the process air mass determined with the aid of the process air mass determination device can be used in conjunction with the temperature difference between the cooled process air and the temperature at the process air outlet in such a way that the absolute energy loss can be determined taking into account the mass of the cooled air.

A method for monitoring the energy management of dryer systems for plastic granules according to the invention comprises at least the following method steps:
Defining a target temperature for the plastic granulate
Measurement of the input temperature of the plastic granulate
Determination of the difference between the target and input temperature of the plastic granulate
Calculation of the energy requirement for drying the plastic granulate and increasing the temperature to the target temperature
Measuring the inlet and outlet temperature of the process air at the drying chamber
Determination of the difference between the inlet and outlet temperature of the process air
Determination of the mass of air fed into the drying chamber
Calculation of the energy introduced into the plastic granules by the process air
Output of the values for the energy requirement and the entered energy.

In embodiments of the method according to the invention, the target temperature for the plastic granulate is selected from a range between approximately 160° C. and 195° C.

In embodiments of the method according to the invention, PET pellets are dried.

In embodiments of the method according to the invention, the inlet temperature of the plastic granules is measured in the area of a store of the plastic granules and/or in the inlet area of the dryer.

In embodiments of the process according to the invention, in order to calculate the energy requirement for drying the plastic granules and raising the temperature to the target temperature, the difference in temperature between the target temperature and the input temperature is multiplied by the specific heat capacity of the material in order to determine the specific energy requirement per kg of plastic granules.

In embodiments, the specific heat capacity is loaded from an electronic storage unit as a function of the material.

In embodiments of the invention, the energy required for drying the plastic granules per unit weight (e.g. kg), the drying effort, is added to the energy required for the temperature increase and thus the specific total energy requirement for drying and heating the plastic granules is determined.

In embodiments of the method according to the invention, the throughput-dependent energy requirement and/or total energy requirement is determined.

In embodiments of the method according to the invention, the mass of the process air supplied to the drying chamber is determined by measuring the volume flow of the supplied process air and multiplying it by the density of the process air.

As an alternative to a volume flow measurement, the flow velocity can also be measured in an area with a known cross-section and integrated over a defined time.

In advantageous embodiments of the method according to the invention, the temperature and/or the air pressure of the process air in the area of the process air mass determination device are measured and taken into account to determine the density of the process air.

In embodiments of the invention, a density table for air is stored in an electronic memory device and is loaded according to the measured value of the temperature and/or the air pressure.

In embodiments of the method according to the invention, the energy introduced into the plastic granules by the process air is calculated by multiplying the temperature difference of the process air by the specific heat capacity of air.

In embodiments of the method according to the invention, the values for the specific and/or absolute energy requirement and the input specific and/or absolute energy are output by showing progression curves of the respective values on a display.

In embodiments of the method according to the invention, the throughput-dependent values are output accordingly.

The output of the progression curves standardized to the plastic granule throughput enables the operator of a corresponding dryer or dryer system to easily set the optimum operating point by adjusting the setting of the process air to the throughput and/or the input temperature of the plastic granules in such a way that the curves lie on top of each other.

When using the method according to the invention for monitoring the energy management of dryer systems for plastic granules on dryers with a circulating process air system, in advantageous embodiments this method additionally comprises the following method steps:
Measurement of the temperature of the process air after cooling for subsequent drying
Determination of the difference between the initial temperature of the process air from the drying chamber and the cooled air
Determination of the cooled process air mass
Calculation of the energy required to cool the air (energy loss)
Output of the calculated energy loss on the display

In embodiments of the invention, the calculated energy loss is output as a progression curve, which is preferably displayed together with the progression curves for the (total) energy demand and the energy input.

In embodiments of the invention, the energy input of a cooling machine used to cool the heat exchanger is taken into account when calculating the energy loss.

In embodiments of the invention, the energy values are output in the unit Wh, preferably standardized to the throughput of plastic granules.

In embodiments according to the invention, the method for monitoring the energy management of dryer systems for plastic granules uses at least one device for monitoring the energy management of dryer systems for plastic granules according to the invention and/or a device for drying plastic granules according to the invention.

A method for drying plastic granules according to the invention comprises the method steps of a method for monitoring the energy management of dryer systems for plastic granules according to the invention, wherein process air is heated by means of a heater and fed into and through the drying chamber of a device for drying plastic granules by means of a blower and absorbs moisture in the drying chamber from a plastic pellet also fed into the drying chamber and heats the plastic pellet.

In advantageous embodiments of the process, the process air is recirculated after leaving the drying chamber, whereby it is first cooled down to a temperature of around 60° C. using a heat exchanger and then dried before being fed back into the area of the fan and then the heater.

In embodiments according to the invention, the method for drying plastic granules uses at least one device for monitoring the energy management of dryer systems for plastic granules according to the invention and/or a device for drying plastic granules according to the invention.

Exemplary embodiments of the invention are shown in the figures explained below. They show:

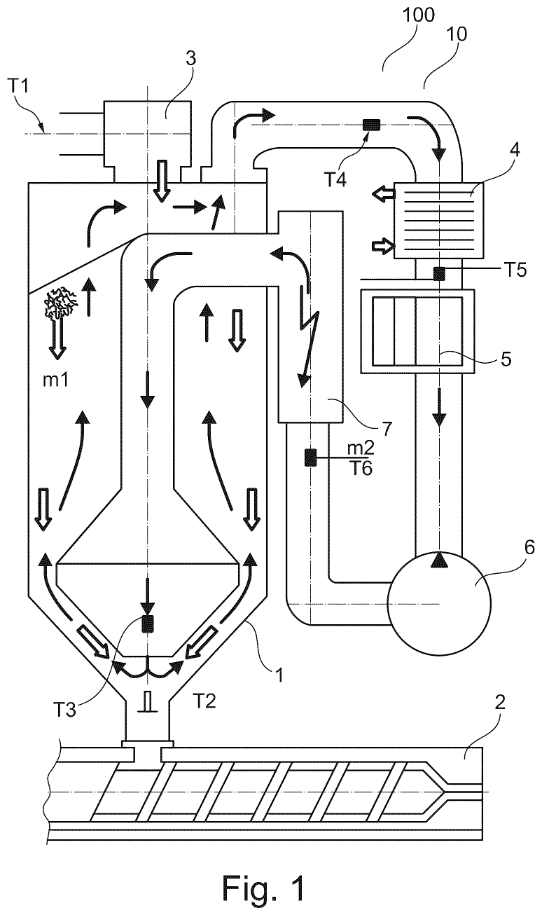

FIG. 1: A schematic representation of a device for drying plastic granules according to the invention,

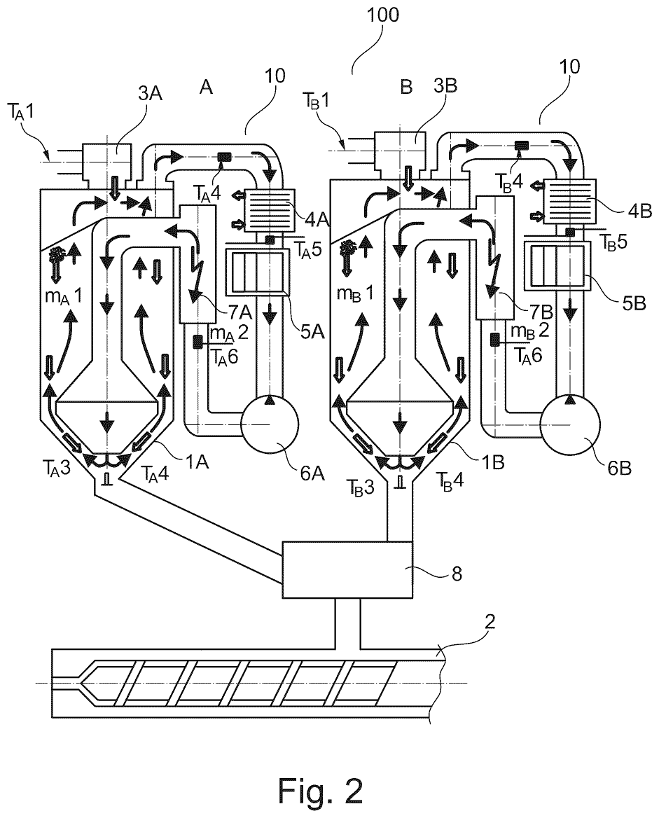

FIG. 2: A dryer system with two devices for drying plastic granules according to the invention,

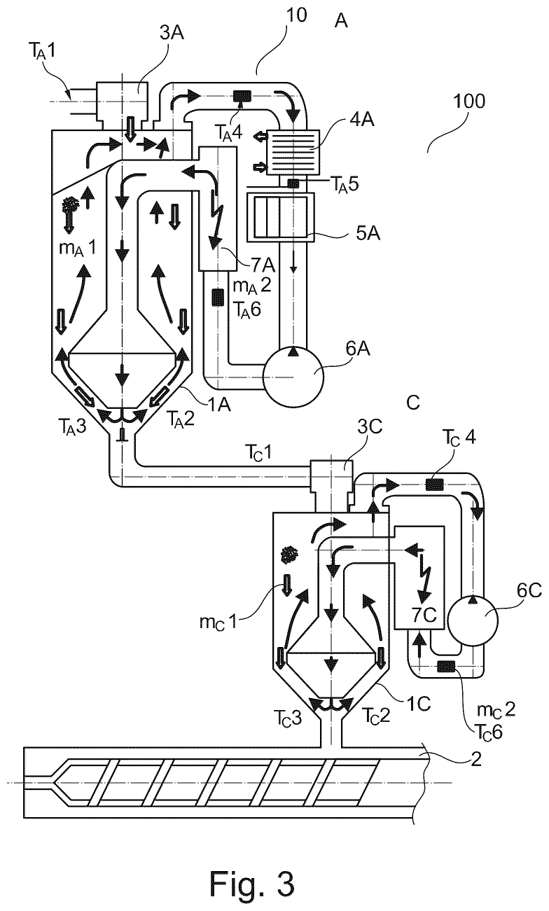

FIG. 3: A two-stage dryer system with a dryer according to the invention and a booster,

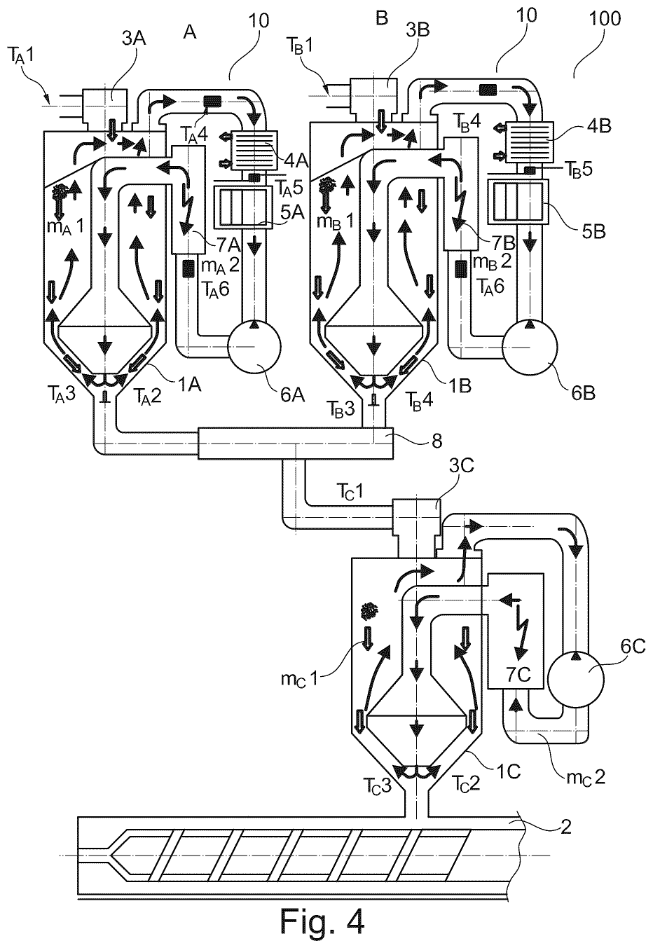

FIG. 4: A combination of the dryer systems shown in FIGS. 2 and 3 and

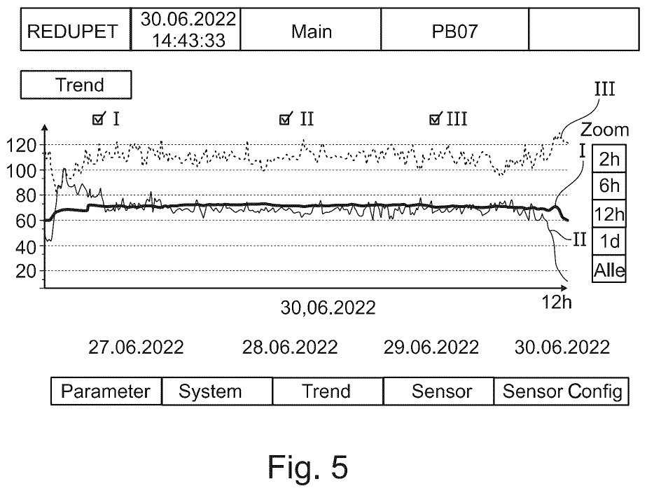

FIG. 5: A representation of the display output of a device for drying plastic granules according to the invention or a device for monitoring energy management on dryer systems for plastic granules.

FIG. 1 shows a drying system (100) comprising a device for drying plastic granulate (10) according to the invention having a drying chamber (1) designed as a drying hopper. A plasticizing screw (2) is connected to the bottom of the drying hopper at the material outlet. This is not a necessary component of the invention, but is an example of the further processing of the dried plastic granulate. An extruder or other devices for further processing the dried plastic granulate can also be connected.

At the top, the drying chamber (1) has a feed device (3) for plastic granulate. The process air can be conducted via a process air line from the process air outlet to a heat exchanger (4), where the process air can be cooled down.

This is followed by a process air drying device (5) for drying the process air. The process air can be fed through the process air line to a heater (7) using a blower (6) and finally into the drying chamber (1) via a process air inlet.

To measure the required temperatures, a first temperature sensor T1 is arranged in the area of the feed device (3) for plastic granules, a second temperature sensor T3 in the area of the process air inlet, a third temperature sensor T4 in the area of the process air outlet, a fourth temperature sensor T5 between the heat exchanger (4) and the process air drying device (5) and a fifth temperature sensor T6 in the area of the process air mass determination device between the blower (6) and the heater (7). The mass flow m2 of the dried process air can be determined with the aid of the process air mass determination device.

The temperature value T2 stands for the specified target temperature of the plastic granulate.

Preferably, at least one additional air pressure sensor is provided in the area of the process air mass determination device(s).

As explained above, the mass flow m1 of the plastic granulate can be measured or otherwise determined in various ways.

The plastic granulate and the process air flow through the drying chamber in counterflow.

The measured values captured by the sensors, the target temperature T2 and the mass flow m1 can be recorded using an evaluation unit and used to calculate the required energy.

FIG. 2 shows a drying system (100) with two devices for drying plastic granules (10), labeled A and B. The individual components of the devices (10) are each supplemented with “A” or “B” in order to assign them to the respective device (10). The plastic granulate dried by both dryers (10) is fed to a material feeder and/or mixer (8).

Different materials can also be processed in the individual dryers, e.g. new plastic granulate in dryer A and recycled material in dryer B.

FIG. 3 shows a drying system (100) with a drying device (10) and a downstream booster (C) and FIG. 4 shows a drying system (100) with two dryers (A, B) and a downstream booster (C).

A booster (5) serves as a unit connected downstream of a drying device (10) to further increase the temperature of the dried plastic granulate. The boosters (5) in the drying systems (100) shown in FIGS. 4 and 5 are also each equipped with a device for monitoring energy management in accordance with the invention.

FIG. 5 shows the output on a display of a device according to the invention. The curves for the total energy requirement (I), the energy input (II) and the losses (III), standardized to the material throughput, are shown for comparison.

The individual curves can be selected or deselected for display. The time resolution of the display can be set to various levels.

The loss curve can also be used to determine whether the process air is being cooled unnecessarily, for example if the cooling valve is stuck or if there is another fault in the cooling system.

1-23. (canceled)

24. A device for monitoring energy management in a dryer system for plastic granules, wherein a dryer system comprises at least one device for drying plastic granules, which has at least one drying chamber, a feed device for plastic granules, a blower and a heater, wherein the device for monitoring the energy management of a dryer system for plastic granules comprises: at least one first temperature sensor arranged in a region of a process air inlet of the drying chamber to measure an inlet temperature of the process air; at least one second temperature sensor arranged in a region of a process air outlet of the drying chamber to measure an outlet temperature of the process air; at least one third temperature sensor for measuring an inlet temperature of the plastic granules; at least one process air mass determination device; and at least one evaluation unit, the evaluation unit being configured to determine a difference between the inlet temperature and the outlet temperature of the process air so that, taking into account heat capacity of air, a specific energy input is determinable and so that, taking into account a mass of supplied process air, an absolute energy input by the process air is determinable, wherein a throughput of the plastic granulate is determined by the evaluation unit and a target temperature for the plastic granulate is retrieved and a difference between the target temperature and the input temperature of the plastic granulate is determined and a specific energy requirement is determined from the temperature difference, taking into account the specific heat capacity of the plastic granulate.

25. The device according to claim 24, wherein the process air mass determination device is arranged in a region of a process air line and comprises an air volume measuring device.

26. The device according to claim 25, further comprising at least one fourth temperature sensor arranged in a region of the air volume measuring device to determine density of the process air in the region of the air volume measuring device considering the temperature.

27. The device according to claim 26, further comprising at least one pressure sensor arranged in the region of the air volume measuring device for determining the air pressure so that density of the process air in the region of the air volume measuring device is determinable considering the air pressure.

28. The device according to claim 24, wherein the evaluation unit is configured to determine the total energy requirement by taking into account energy required for the temperature increase and energy required for actual drying of the plastic granules.

29. The device according to claim 24, further comprising an output device configured to output a determined specific and/or absolute energy requirement and a determined specific and/or absolute energy input.

30. The device according to claim 24, further comprising, in order to detect energy required to cool the process air, at least one fifth temperature sensor arranged in the process air line of the dryer system downstream of a heat exchanger in a direction of flow, so that a specific energy loss is determinable by the evaluation unit from a difference between the output temperature measured in a region of the process air outlet and a measured temperature value of the cooled-down process air.

31. The device according to claim 30, wherein the process air mass determined by the process air mass determination device is used in conjunction with the temperature difference between the cooled process air and the temperature at the process air outlet so that an absolute energy loss is determinable taking into account the mass of the cooled air.

32. A device for drying plastic granules, comprising: least one drying chamber; a feed device for plastic granules; a blower; a heater; and a device for monitoring energy management of a dryer system for plastic granules according to claim 24.

33. The device according to claim 32, further comprising a control unit operative to control the blower for adjusting the mass fed into the drying chamber and/or the heater for adjusting the inlet temperature of the process air to minimize a deviation of the energy input from the energy requirement determined by the evaluation unit so as to optimize automatic control of the energy input with regard to the actual energy requirement.

34. A method for monitoring energy management of a dryer system for plastic granulate, comprising the steps of:
specifying a target temperature for the plastic granulate;
measuring input temperature of the plastic granulate;
determining a difference between a target temperature and the input temperature of the plastic granulate;
calculating an energy requirement for drying the plastic granulate and increasing the input temperature to the target temperature;
measuring an inlet temperature and an outlet temperature of process air at a drying chamber;
determining a difference between the inlet temperature and the outlet temperature of the process air;
determining mass of the process air fed into the drying chamber;
calculating energy introduced into the plastic granulate by the process air; and
outputting values for the energy requirement and the introduced energy.

35. The method according to claim 34, including selecting the target temperature for the plastic granulate to be from a range between about 160° C. and 195° C.

36. The method according to claim 34, including measuring the inlet temperature of the plastic granules in a region of a store of the plastic granules and/or in an inlet region of the dryer.

37. The method according to claim 34, including determining a specific energy requirement per kg of plastic granules by multiplying the difference between the target temperature and the input temperature by a specific heat capacity of the plastic granulate material in order to calculate the energy requirement for drying the plastic granules and raising the temperature to the target temperature.

38. The method according to claim 37, including determining the specific total energy requirement for drying and heating the plastic granules by adding the energy required for drying the plastic granules per unit weight to the energy required for the temperature increase.

39. The method according to claim 34, including determining a throughput-dependent energy requirement and/or a total energy requirement.

40. The method according to claim 34, including determining a mass of the process air supplied to the drying chamber by measuring volume flow of the supplied process air and multiplying the volume flow by density of the process air.

41. The method according to claim 40, including measuring the temperature and/or air pressure of the process air in a region of the process air mass determination device and considering the measured temperature and/or air pressure to determine the density of the process air.

42. The method according to claim 34, including calculating energy introduced into the plastic granules by the process air by multiplying the temperature difference of the process air by the specific heat capacity of air.

43. The method according to claim 34, including outputting values for the specific and/or absolute energy requirement and the specific and/or absolute energy entered by showing curves of the values on a display.

44. The method according to claim 43, further comprising the steps of:
measuring the temperature of the process air after cooling down for subsequent drying;
determining a difference between the initial temperature of the process air from the drying chamber and the cooled process air;
determining mass of the cooled process air;
calculating energy required to cool the air (energy loss); and
outputting the calculated energy loss on the display.

45. The method according to claim 34, including using a device for monitoring energy management in a dryer system for plastic granules, wherein a dryer system comprises at least one device for drying plastic granules, which has at least one drying chamber, a feed device for plastic granules, a blower and a heater, wherein the device for monitoring the energy management of a dryer system for plastic granules comprises: at least one first temperature sensor arranged in a region of a process air inlet of the drying chamber to measure an inlet temperature of the process air; at least one second temperature sensor arranged in a region of a process air outlet of the drying chamber to measure an outlet temperature of the process air; at least one third temperature sensor for measuring an inlet temperature of the plastic granules; at least one process air mass determination device; and at least one evaluation unit, the evaluation unit being configured to determine a difference between the inlet temperature and the outlet temperature of the process air so that, taking into account heat capacity of air, a specific energy input is determinable and so that, taking into account a mass of supplied process air, an absolute energy input by the process air is determinable, wherein a throughput of the plastic granulate is determined by the evaluation unit and a target temperature for the plastic granulate is retrieved and a difference between the target temperature and the input temperature of the plastic granulate is determined and a specific energy requirement is determined from the temperature difference, taking into account the specific heat capacity of the plastic granulate.

46. A method for drying plastic granules, comprising the steps of: carrying out the steps of claim 34; heating process air with a heater; and feeding the process air into and through the drying chamber of a device for drying plastic granules by a blower so that the process air absorbs moisture in the drying chamber from plastic granules also fed into the drying chamber and heats the plastic granules.
